(19) United States
(12) Patent Application Publication
(10) Pub. No.: US 2026/0246054 A1
(43) Pub. Date: Aug. 20, 2026

(54) WEARABLE RING WITH REMOVABLE BATTERY

(71) Applicant: ULTRAHUMAN HEALTHCARE PVT LTD, Bangalore (IN)

(72) Inventors: Adhit SHET, Abu Dhabi (AE); Ritwik RAJ, Abu Dhabi (AE); Vatsal SINGHAL, Abu Dhabi (AE); Mohit KUMAR, Abu Dhabi (AE)

(73) Assignee: ULTRAHUMAN HEALTHCARE PVT LTD, Bangalore (IN)

(21) Appl. No.: 19/057,895

(22) Filed: Feb. 19, 2025

(51) Int. Cl. H01M 50/247; A44C 9/00; H01M 10/48

(52) U.S. Cl. CPC H01M 50/247; H01M 10/488; A44C 9/0053; H01M 2220/20

(57) ABSTRACT

The present invention provides a wearable ring comprising a ring component that includes one or more sensors and functional components, and a removable battery component. The removable battery component houses a battery and is detachably engaged with the ring component to power the sensors and functional components. The wearable ring of the present invention also includes various embodiments that provide flexibility and convenience for the user. For example, the removable battery component may be engaged with the ring component using a magnetic clasp, a sliding lock, or a snap-fit design. Additionally, the ring component may include a residual battery to provide continuous power even when the removable battery component is disengaged.

### FIELD OF INVENTION

The present invention relates to wearable devices and, more specifically, to a wearable ring that includes a removable battery for powering one or more sensors and functional components.

### BACKGROUND OF INVENTION

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

Wearable rings have emerged as a compact and increasingly popular wearable device, that offers a range of advanced functionalities, making them highly appealing for various applications, including health monitoring, fitness tracking, and payment capabilities. These devices have the ability to track a wide variety of biometric and activity data, such as heart rate, sleep patterns, movement, calories burned, and more, providing users with actionable insights for improving their overall well-being. Additionally, wearable rings may include NFC or Bluetooth technology to enable secure, touchless payments, enhance connectivity, and streamline everyday tasks.

Despite the benefits that wearable rings offer, one of the major limitations in the current landscape of wearable devices is the battery life. Due to the compact size and design constraints of wearable rings, manufacturers often integrate small, non-removable batteries to power the device. These batteries, while capable of supporting the ring's functions for a certain period, are ultimately limited by the battery's lifespan.

The most significant issue arising from the use of integrated, non-replaceable batteries in wearable rings is that, once the battery depletes, the entire device needs to be replaced. Moreover, users must replace the entire device once the battery no longer holds a charge, which is often more expensive than simply replacing the battery. Over time, this can become a financial burden for consumers, particularly as wearable rings can be a significant investment due to their multifunctionality. The disposal of entire devices contributes to e-waste, which is a growing environmental concern. The inability to replace just the battery in wearable rings means that more devices are discarded than necessary, increasing the volume of electronic waste and the associated environmental harm.

The need to replace the entire device when the battery degrades either due to capacity fading or battery cycle aging is also inconvenient for users. It forces them to purchase a new device or go without one entirely while they wait for a replacement, disrupting the continuity of health tracking, fitness monitoring, and other essential functions. With advancements in technology, consumers may also face the challenge of device obsolescence. While the battery in a wearable ring may no longer function, the technology in the ring itself may still be operational. This gap between device technology and battery lifespan can lead to unwanted electronic waste.

To address these challenges, a modular wearable ring with a removable battery provides an effective solution. This invention allows the battery component to be easily detached and replaced, giving users the flexibility to replace just the battery when it degrades, without the need to purchase an entirely new device.

### SUMMARY OF INVENTION

The summary is provided to introduce aspects related to wearable devices, and the aspects are further described below in the detailed description. This summary is not intended to identify essential features of the claimed subject matter, nor is it intended for use in determining or limiting the scope of the claimed subject matter.

In one aspect, the present invention relates to a wearable ring, comprising a ring component including one or more sensors and functional components in a housing and a removable battery component. The removable battery component includes a battery positioned within the removable battery component and a plurality of first part of electrical connectors coupled to the battery. The removable battery component is detachably engaged to the ring component to form the wearable ring to be worn by a user.

According to an embodiment of the present invention, a shape of the ring component and the removable battery component is circumferential.

In yet another embodiment of the present invention, the removable battery component is engaged with the ring component with at least one of magnetic clasp, a sliding lock, or a snap-fit design.

According to an embodiment of the present invention, the ring component further houses a residual battery.

According to an embodiment of the present invention, the ring component further houses a plurality of second part of electrical connectors.

According to an embodiment of the present invention, upon engagement of the removable battery component with the ring component, the plurality of the first part of electrical connectors is engaged with the plurality of the second part of electrical connectors to power the one or more sensors and functional components.

According to an embodiment of the present invention, the wearable ring further comprises an outer shell adapted to cover the ring component and the removable battery component.

According to an embodiment of the present invention, upon disengagement of the removable battery component with the ring component, the residual battery is adapted to power the one or more sensors and functional components of the ring component.

In another embodiment of the present invention, the wearable ring further comprises a switching mechanism to switch power source from the residual battery to the removable battery component, upon engagement of the removable battery component with the ring component.

According to an embodiment of the present invention, the plurality of first part of electrical connectors and the plurality of second part of electrical connectors include at least one of spring-loaded pins, pogo pins, or magnetic contacts that automatically engage upon attachment of the removable battery component to the ring component.

In another embodiment of the present invention, the wearable ring further comprises an indicator configured to notify user of a state of the removable battery component.

According to an embodiment of the present invention, the indicator includes at least one of LED indicator or an alarm or any combination thereof.

In another embodiment of the present invention, the removable battery component of the wearable ring comprises one or more rechargeable batteries.

In another aspect, the present invention relates to a removable battery component, including a battery positioned within the removable battery component and a plurality of part of electrical connectors coupled to the battery and positioned on the removable battery component. The removable battery component is detachably engaged to a ring component to form a wearable ring to be worn by a user.

According to an embodiment of the present invention, the removable battery component is engaged with the ring component with at least one of magnetic clasp, a sliding lock, or a snap-fit design.

In another embodiment of the present invention, the plurality of the first part of electrical connectors is engaged with the ring component to power the one or more sensors and functional components.

According to an embodiment of the present invention, the plurality of first part of electrical connectors include spring-loaded pins, pogo pins, or magnetic contacts.

In another embodiment of the present invention, the removable battery component comprises one or more rechargeable batteries.

According to an embodiment of the present invention, the removable battery component further comprises a charging circuit to charge the one or more batteries of the removable battery component.

The wearable ring with a detachable battery component offers several advantages. The removable battery component allows users to easily replace or recharge the battery without needing to remove or replace the entire device. The inclusion of a residual battery ensures that the device remains functional even if the removable battery is exhausted or removed. The outer shell can be customized for aesthetic appeal and user comfort. The automatic switching mechanism between the residual and removable batteries ensures seamless operation without interruption. Therefore, the present invention provides efficient maintenance, reduces e-waste, and offers an improved user experience by minimizing downtime during charging or battery replacement.

Other aspects and advantages of the invention will become apparent from the following description, taken in conjunction with the accompanying drawings, illustrating by way of example, the principles of the invention.

### BRIEF DESCRIPTION OF DRAWINGS

The accompanying drawings constitute a part of the description and are used to provide a further understanding of the present invention. Such accompanying drawings illustrate the embodiments of the present invention used to describe the principles of the present invention. The embodiments are illustrated by way of example and not by way of limitation in the figures of the accompanying drawings in which references indicate similar elements. It should be noted that references to “an” or “one” embodiment in this invention are not necessarily to the same embodiment, and they mean at least one. In the drawings:

FIG. 1 illustrates an exploded view of a wearable ring with a replaceable battery component, in accordance with an embodiment of the present invention;

FIG. 2 illustrates an exemplary diagram highlighting engagement mechanism of a ring component with the replaceable battery, in accordance with an embodiment of the present invention;

FIG. 3 illustrates an exploded view of the wearable ring with an outer shell, in accordance with an embodiment of the present invention;

FIG. 4 illustrates an isometric view of the wearable ring with the outer shell, in accordance with an embodiment of the present invention.

### DETAILED DESCRIPTION OF EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present invention addresses the limitations of conventional wearable rings by providing an improved wearable ring with a removable battery component, offering ease of use, efficient power management, and enhanced user experience. The flexibility in structure and the ability to replace or recharge the battery component ensures that the wearable ring remains functional and practical for everyday use. The wearable ring of the present invention combines innovative features to ensure functionality, comfort, and convenience for the user. The structure allows for easy power management with a removable battery component, providing the user with extended battery life and seamless device operation. The detailed aspects of the wearable ring are discussed below.

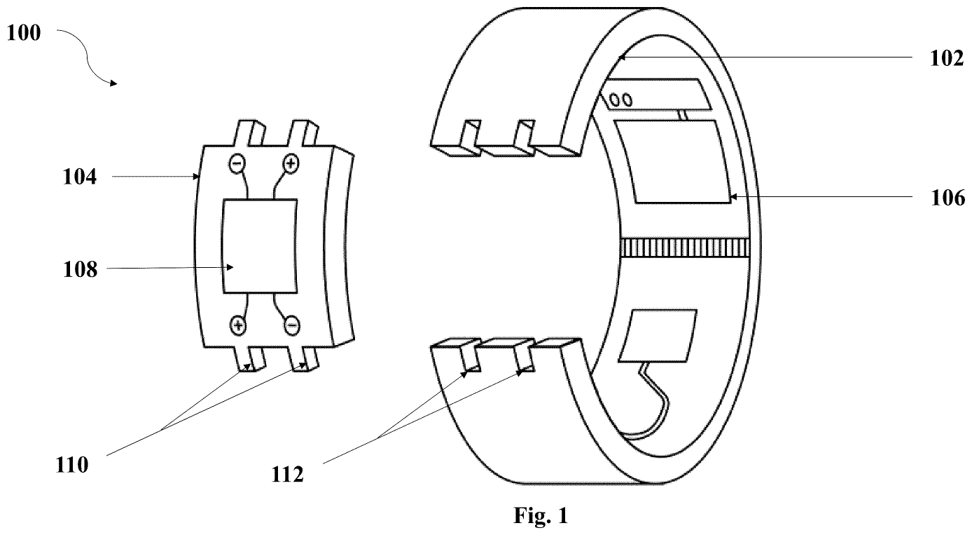

FIG. 1 illustrates an exploded view of the wearable ring (100) with the replaceable battery component (104), in accordance with an embodiment of the present invention. The wearable ring (100) comprises a ring component (102) and the removable battery component (104). The ring (100) component further including one or more sensors and functional components in a housing (106). The removable battery component (104) includes a battery (108) positioned within the removable battery component (104). The removable battery component (104) is detachably engaged to the ring component (102) to form the wearable ring (100) to be worn by a user.

The ring component (102) of the wearable ring (100) is the primary structure that houses one or more sensors and functional components. These components may include sensors for tracking various metrics such as heart rate, temperature, movement, or biometric data, as well as functional elements such as communication modules, LEDs, or haptic feedback systems. The sensors and functional components are housed within the housing (106) in the ring (100), which protects the internal electronics and ensures user safety during normal wear.

The housing (106) of the ring component (102) is designed to be durable, lightweight, and comfortable to wear for extended periods. The materials used in the housing (106) can be metals, polymers, or composites, depending on the desired strength, weight, and aesthetics. The inner surface of the housing (106) may also be ergonomically shaped to conform to the user's finger, ensuring a secure and comfortable fit.

The removable battery component (104) is a critical part of the wearable ring (100), as it provides the necessary power to the sensors and functional components housed within the ring (100). The removable battery component (104) comprises battery (108), positioned within the removable battery component (104), the battery (108) provides power to the wearable ring (100). The battery (108) may be a rechargeable lithium-ion, lithium-polymer, or other types of rechargeable batteries, ensuring long-lasting use.

The battery (108) is coupled to a set of electrical connectors (110) located on the removable battery component (104). These connectors (110) allow the battery to transfer power to the sensors and functional components in the housing (106) of the ring component (102) once engaged.

The removable battery component (104) is designed to be easily detached and reattached to the ring component (102). This feature is critical for providing the user with a convenient means to replace or recharge the battery (108), especially if the battery (108) is removable and designed to be independently charged.

In an optional embodiment, the ring component (102) further comprises a residual battery in the housing (106). The residual battery serves as an auxiliary power source, ensuring that the sensors and functional components remain operational even when the removable battery component (104) is detached. This feature enhances the reliability of the ring (100), allowing it to continue functioning without interruption when the removable battery component (104) is removed for charging or replacement.

In an embodiment, both the ring component (102) and the removable battery component (104) are designed with a circumferential shape. This ensures that the wearable ring (100) remains cohesive and aesthetically pleasing when worn on the user's finger. The circumferential design also provides a seamless look, with the removable battery component (104) fitting securely against the ring component (102).

In the present invention, power transfer between the ring component (102) and the removable battery component (104) is achieved through electrical connectors. There are two parts in the said connectors. A plurality of first part of electrical connectors (110) may be located on the removable battery component (104). These connectors (110) are designed to interface with corresponding connectors on the ring component (102). Further, a plurality of second part of electrical connectors (112) may be housed within the ring component (102) and are responsible for receiving power from the removable battery component (104).

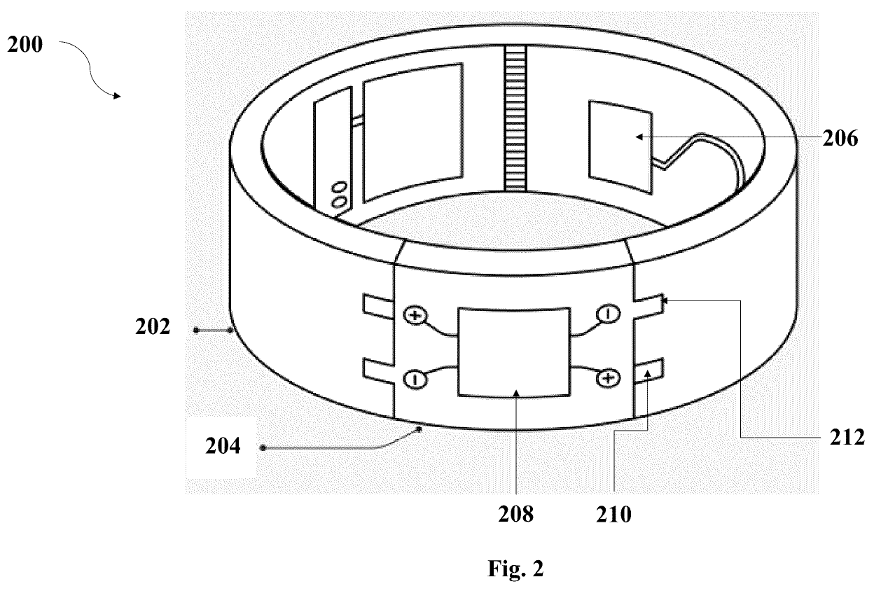

FIG. 2 illustrates an exemplary diagram highlighting engagement mechanism of the wearable ring (200), in accordance with an embodiment of the present invention. The engagement mechanism between the ring component (202) and the removable battery component (204) is an essential feature. This mechanism allows the battery (208) to remain securely attached to the ring (200) while enabling easy detachment when necessary. The engagement mechanism may use several methods.

In one embodiment, the ring component (202) and the removable battery component (204) may be engaged via magnetic clasp. This is a simple, easy-to-use attachment mechanism where magnets on the removable battery component (204) align with corresponding magnets on the ring component (202). The magnetic clasp ensures the removable battery component (204) remains securely attached while still allowing for quick detachment when needed.

In another embodiment, the ring component (202) and the removable battery component (204) may be engaged via sliding lock. This mechanical locking system allows the removable battery component (204) to slide into the ring component (202), with a locking mechanism holding the two parts together securely. The sliding lock ensures the components remain firmly attached during normal use.

In yet another embodiment, the ring component (202) and the removable battery component (204) may be engaged via snap-fit design. The snap-fit mechanism utilizes interlocking features on the ring and removable battery components (202, 204) that click together. This mechanism is easy to operate while maintaining a secure fit, ensuring the battery (208) stays attached during regular activities.

In another embodiment, upon engagement of the removable battery component (204) with the ring component (202), the plurality of the first part of electrical connectors (210) is engaged with the plurality of the second part of electrical connectors (212) to power the one or more sensors and functional components within the housing (206) of the ring (200).

Upon engagement, the first and second parts of the electrical connectors (210, 212) automatically align and engage, creating an electrical connection that allows the battery (208) to supply power to the sensors and functional components within the housing (206) of the ring (200). The connectors (210, 212) can be designed as spring-loaded pins, pogo pins, or magnetic contacts, which automatically engage when the components are attached. This ensures a seamless transfer of power without requiring additional manual effort from the user.

The engagement of the connectors (210, 212) provides a secure and reliable electrical connection that allows for continuous power supply to the sensors and functional components during use.

In an embodiment, the wearable ring (200) includes a power switching mechanism that ensures smooth operation of the ring (200). The power switching mechanism automatically switches the power source from the residual battery in the housing (206) to the removable battery component (204) upon engagement. The residual battery is typically smaller in capacity than the removable battery (208) but is still capable of powering essential functions, such as basic sensor operation, for a short period of time. This ensures that the wearable ring (200) remains useful even if the user forgets to recharge or replace the removable battery.

When the removable battery component (204) is attached, the power switching mechanism seamlessly shifts the power supply to the larger removable battery (208), ensuring the ring component (202) receives the required power for optimal performance.

If the removable battery component (204) is disengaged, the residual battery in the ring component (202) will continue to power the sensors and functional components, ensuring the wearable ring (200) does not lose power abruptly. The residual battery eliminates downtime during battery replacement, ensuring continuous tracking and operation, crucial for health monitoring scenarios. The switching mechanism ensures that the user does not need to manually control the power source, making the device user-friendly and intuitive.

In an embodiment, the wearable ring (200) includes an indicator to ensure that the user is always informed of the battery status. The indicator notifies the user about the state of the removable battery component (204). The indicator can take several forms such as LED indicator, app-based notifications, an auditory signal, or any combination thereof, to alert user of low battery health or degraded battery. The LED light can be incorporated into the ring (200) to show various power states, such as charging, full, low, or empty. The LED may use different colors to indicate different battery levels. The auditory alarm may be used to alert the user when the battery is low or needs attention. Further, an app-based notification pop-up may also be used to alert the user when the battery is low or needs attention. Moreover, any combination of visual, app-based notification, or auditory signals may be used for better user awareness. These indicators ensure that the user is always aware of the battery status, allowing for proactive management of battery life and ensuring the wearable ring (200) remains functional.

In an embodiment, the removable battery component (204) includes one or more rechargeable batteries (208). These batteries can be charged either through a wired connection or using wireless charging methods, such as induction charging. The inclusion of rechargeable batteries ensures long-term use of the wearable ring while minimizing the need for battery replacement.

To recharge the battery, the removable battery component (204) comprises a charging circuit to charge the one or more batteries (208) of the removable battery component (204). The user simply detaches the removable battery component (204) and connects it to a charging device. Wireless charging stations or docking stations may be used for added convenience, allowing the user to charge the battery without the need for physical connectors.

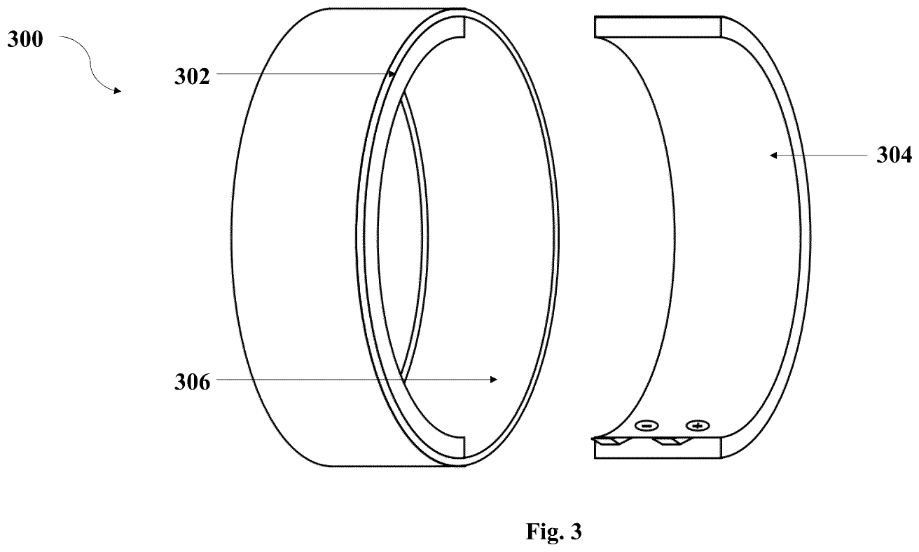

FIG. 3 illustrates an exploded view of the wearable ring (300) with an outer shell (306), in accordance with an embodiment of the present invention. In another embodiment of the present invention, the wearable ring (300) includes an outer shell (306) to enhance the durability, comfort, and appearance of the wearable ring (300). The ring (300) may be covered with the outer shell (306) that protects both the ring and removable battery components (302, 304). The outer shell (306) shields the internal electronics from external damage due to impacts, moisture, and dust, ensuring the longevity of the wearable ring (300).

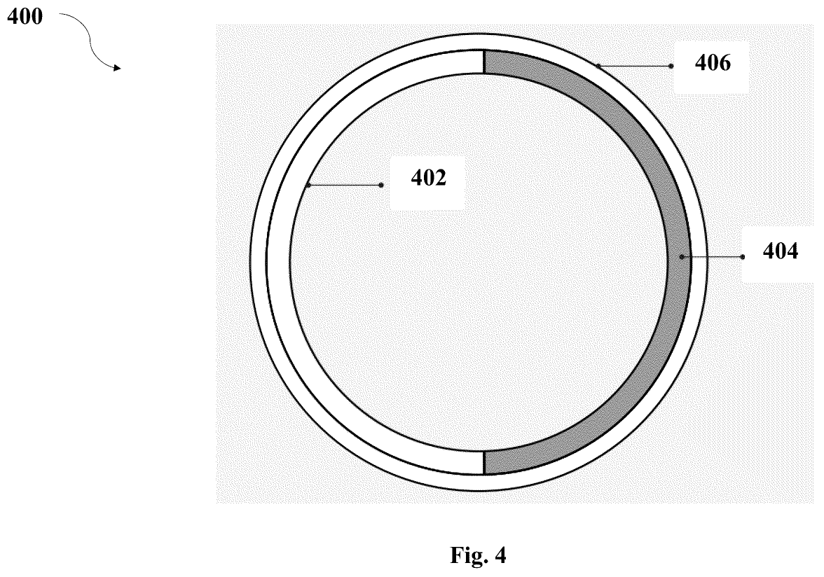

FIG. 4 illustrates an isometric view of the wearable ring (400) with the outer shell (406), in accordance with an embodiment of the present invention. The outer shell (406) is adapted to cover the ring component (402) and the removable battery component (404).

The outer shell (406) may be made from flexible and soft materials, such as silicone, which ensures that the ring (400) remains comfortable to wear for extended periods. This material also offers some level of flexibility, making it easier to wear and adjust to different finger sizes. In another embodiment, the outer shell (406) may be made from hard plastic material which are sturdy enough to secure the ring component and removable battery component together and to protect against any external impact. In an embodiment, the outer shell (406) may comprise at least one of silicon shell cover, metal shell cover etc.

The outer shell (406) may be removable or integrated. If removable, the user can easily replace or customize the shell as needed. The outer shell (406) makes the ring component and the removable battery component tamper proof as well as provides user friendly locking system, ensuring that the components remains secure under rigorous physical activity.

By enabling users to replace only the battery, the overall cost of ownership for the wearable ring is greatly reduced. Users can extend the life of their devices without needing to buy a completely new ring. This makes the device more affordable in the long run, especially when compared to the costs associated with replacing a whole device. With a replaceable battery, the environmental impact is significantly reduced. Instead of disposing of an entire device, users can simply replace the depleted battery and continue to use their existing wearable ring. This reduces e-waste and encourages sustainability in the wearable technology industry.

The ability to replace the battery when necessary greatly improves the user experience. Users can continue using the wearable ring without the interruption caused by a dead or depleted battery, and they do not have to wait for a new device to arrive. Moreover, the design of the removable battery component can make it easy to swap the battery, allowing for quick replacement and minimal downtime.

The wearable ring can remain functional for a much longer period. Even as battery technology evolves and new features are introduced to wearable rings, the device itself can be kept up-to-date with the addition of a new, more powerful battery. This helps ensure that the wearable technology does not become obsolete prematurely due to the limitations of its power source.

A modular structure also opens the door for more customization options. Users could choose from different battery sizes or types based on their individual needs (e.g., larger batteries for more extended usage or smaller batteries for lighter designs). This flexibility caters to a wider range of users and preferences.

The removable battery also incorporates safety features that make the replacement process safer. For instance, the removable battery could be equipped with mechanisms to prevent overcharging, overheating, or short-circuiting, ensuring that users can replace the battery without compromising the safety or functionality of the device.

Therefore, the wearable ring with the removable battery component provides an innovative solution for wearable devices for health monitoring, fitness tracking, and payment systems by offering flexibility in power management, improved user experience, and ease of use. The structure allows users to continue using the ring even if the primary battery is removed or depleted, while the seamless engagement and disengagement mechanism ensures that the device remains practical and convenient for daily wear.

In view of the present disclosure, which describes the present invention, all changes, modifications and, variations within the meaning and range of equivalency are considered within the scope of the invention. It is to be understood that the aspects and embodiment of the disclosure described above may be used in any combination with each other. Several of the aspects and embodiment may be combined together to form a further embodiment of the disclosure.

1. A wearable ring, comprising:
a ring component including:
one or more sensors and functional components in a housing;
a residual battery in the housing; and
a first set of electrical connectors;
a removable battery component including:
a battery positioned within the removable battery component; and
a second set of electrical connectors coupled to the battery,
wherein the removable battery component is detachably engaged to the ring component to form the wearable ring to be worn on a finger of a user,
a switching mechanism to switch a power source to the one or more sensors and the functional components from the battery positioned within the removable battery component to the residual battery upon disengagement of the removable battery component from the ring component and to switch the power source from the residual battery to the battery positioned within the removable battery component upon engagement of the removable battery component with the ring component;
an indicator to provide an indication to notify the user of a power level state of the battery positioned within the removable battery component when the removable battery component is engaged with the ring component, wherein the indicator is to provide the indication via at least one of a visual indicator on the wearable ring, an audible indicator on the wearable ring, and an app-based notification; and
wherein the first set of electrical connectors and the second set of electrical connectors include at least one of spring-loaded pins, pogo pins, or magnetic contacts that automatically engage upon attachment of the removable battery component to the ring component without requiring manual input from the user.

2. The wearable ring of claim 1, wherein a shape of the ring component and the removable battery component is circumferential.

3. The wearable ring of claim 1, wherein the removable battery component is engaged with the ring component with at least one of magnetic clasp, a sliding lock, or a snap-fit design.

4. (canceled)

5. (canceled)

6. The wearable ring of claim 1, wherein upon engagement of the removable battery component with the ring component, the first set of electrical connectors is engaged with the second set of electrical connectors to power the one or more sensors and functional components.

7. The wearable ring of claim 1, further comprising an outer shell adapted to cover the ring component and the removable battery component.

8. The wearable ring of claim 7, wherein the outer shell comprises at least one of flexible silicon shell cover or metal shell cover, which is mountable over the wearable ring.

9.-10. (canceled)

11. The wearable ring of claim 1, wherein the first set of electrical connectors and the second set of electrical connectors include at least one of spring-loaded pins, pogo pins, or magnetic contacts that automatically engage upon attachment of the removable battery component to the ring component.

12. (canceled)

13. The wearable ring of claim 1, wherein the indicator includes at least one of an LED indicator, an alarm, or any combination thereof.

14. The wearable ring of claim 1, wherein the removable battery component comprises one or more rechargeable batteries.

15. A wearable ring comprising:
a ring component including:
one or more sensors and functional components in a housing;
a residual battery in the housing;
a first set of electrical connectors;
a switching mechanism; and
an indicator;
a removable battery component detachably engaged to the ring component to form a wearable ring to be worn on a finger of a user, the removable battery component comprising:
a battery positioned within the removable battery component;
a second set of electrical connectors coupled to the battery and positioned on the removable battery component, wherein the second set of electrical connectors are to engage the first set of electrical connectors when the removable battery component is engaged with the ring component;
wherein the switching mechanism is to switch a power source to the one or more sensors and the functional components from the battery positioned within the removable battery component to the residual battery upon disengagement of the removable battery component from the ring component and to switch the power source from the residual battery to the battery positioned within the removable battery component upon engagement of the removable battery component with the ring component;
wherein the indicator is to provide an indication to notify the user of a power level state of the battery positioned within the removable battery component when the removable battery component is engaged with the ring component, wherein the indicator is to provide the indication via at least one of a visual indicator on the wearable ring, an audible indicator on the wearable ring, and an app-based notification; and
wherein the first set of electrical connectors and the second set of electrical connectors include at least one of spring-loaded pins, pogo pins, or magnetic contacts that automatically engage upon attachment of the removable battery component to the ring component without requiring manual input from the user.

16. The wearable ring of claim 15, wherein the removable battery component is engaged with the ring component with at least one of magnetic clasp, a sliding lock, or a snap-fit design.

17. The wearable ring of claim 15, wherein the second set of electrical connectors is engaged with the ring component to power the one or more sensors and functional components.

18. The wearable ring of claim 15, wherein the second set of electrical connectors include spring-loaded pins, pogo pins, or magnetic contacts.

19. The wearable ring of claim 15, wherein the removable battery component comprises one or more rechargeable batteries.

20. The wearable ring of claim 15, further comprising a charging circuit to charge the battery positioned within the removable battery component.
